(19) United States
(12) Patent Application Publication
(10) Pub. No.: US 2008/0157991 A1
(43) Pub. Date: Jul. 3, 2008

(54) REMOTE MONITOR DEVICE WITH SENSOR TO CONTROL MULTIMEDIA PLAYBACK

(75) Inventors: MANDAYAM THONDAR RAGHUNATH, Bangalore (IN); CHANDRASEKHAR NARAYANASWAMI, Wilton, CT (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/619,609

(22) Filed: Jan. 3, 2007

(51) Int. Cl. G08B 21/00

(52) U.S. Cl. 340/686.1

(57) ABSTRACT

A multimedia playback system includes a multimedia player having a playback control circuit, and a remote monitor device for remotely reproducing at least one of audio and/or video of the multimedia presentation. The remote monitor device includes a wired or wireless unit for receiving the multimedia presentation, a speaker and/or a display, and a sensor for determining when the remote monitor device has been applied to a user, and when the remote monitor device has been removed from the user. A sensor condition detection circuit controls the playback control circuit to one of initiate and resume the multimedia presentation when the sensor determines when the remote monitor device has been applied to a user, and for controlling the playback control circuit to one of pause and stop the multimedia presentation when the sensor determines when the remote monitor device has been removed from the user.

### BACKGROUND OF THE INVENTION

1. Field of the Invention

The present invention generally relates to a multimedia playback system including a multimedia player having a playback control circuit that controls playback of a multimedia presentation, and a remote monitor device that includes at least one sensor for determining when the remote monitor device has been placed on or removed from a user. An output signal from the sensor controls the playback control circuit to either pause or resume the multimedia presentation.

2. Description of the Related Art

Conventional systems of personal and/or portable multimedia players generally allow a user to control a user input interface on the multimedia device to control playback of a multimedia presentation. However, the user may need to remove a remote monitor device, such as headphones, or the combination of headphones and a wearable monitor display device, without operating the user input interface when a situation would require a user to concentrate on other activities, for example, when answering a mobile phone, responding to a conversation, etc.

Typically, when a user removes the remote monitor device during playback of a multimedia presentation, the multimedia presentation on the portable multimedia player continues to play without interruption. Thus, a user will fail to hear or see the portion of the multimedia presentation that was playing while the user's remote monitor device was removed.

Some conventional personal multimedia players control playback by stopping the multimedia presentation when the user removes the headphones from the headphone jack of the multimedia player. However, this configuration fails to determine if the user removes the headphones from the user's ears during playback of a multimedia presentation to stop playback.

Thus, such a conventional system and method requires either removal of the headphones from the headphone jack of the multimedia player or the user's operation of the user input controls to pause or stop playback of a multimedia presentation. Likewise, the user must operate the user input interface of the multimedia player to initiate or resume playback of the multimedia presentation.

### SUMMARY OF THE INVENTION

In view of the foregoing and other exemplary problems, drawbacks, and disadvantages of the conventional systems and structures, a purpose of the exemplary aspects of the present invention is to provide a system and apparatus for controlling playback of a multimedia presentation on a media player by sensors in a remote monitor device that determines if the remote monitor device has been removed from or replaced on a user.

An exemplary aspect of the present invention includes a multimedia player including a playback control circuit that controls playback of a multimedia presentation, and a remote monitor device for reproducing audio and/or video of the multimedia presentation. The remote monitor device may include wires or a wireless transmission protocol for receiving the audio and/or video of the multimedia presentation, at least one speaker or display for reproducing audio or video from the wires or wireless transmission protocol, and at least one sensor for determining when the remote monitor device has been applied to a user, and when the remote monitor device has been removed from the user.

The multimedia player further includes a multimedia signal connector for connecting to the wires or wireless means for receiving the audio or video input for audio or video reproduction, a sensor power and signal connector for connecting and providing power to the at least one sensor, and a sensor condition detection circuit for controlling the playback control circuit to one of initiate and resume the multimedia presentation when the at least one sensor determines when the remote monitor device has been applied to a user, and for controlling the playback control circuit to one of pause and stop the multimedia presentation when the at least one sensor determines when the remote monitor device has been removed from the user.

In another exemplary aspect of the present invention, a multimedia playback system, the system includes a multimedia player including a playback control circuit that controls playback of a multimedia presentation, and a remote monitor device for reproducing audio and/or video of the multimedia presentation. The remote monitor device include wires or a wireless transmission protocol for receiving audio and/or video of the multimedia presentation, at least one speaker or display for reproducing audio and/or video from the wires or wireless transmission protocol, and at least one sensor for determining when the remote monitor device has been applied to a user, and when the remote monitor device has been removed from the user.

The multimedia player further includes remote monitor device connector for connecting to the wires or wireless transmission protocol for receiving the audio and/or video input for audio and/or video reproduction and for connecting and providing power to the at least one sensor, and a sensor condition detection circuit for controlling the playback control circuit to one of initiate and resume the multimedia presentation when the at least one sensor determines when the remote monitor device has been applied to a user, and for controlling the playback control circuit to one of pause and stop the multimedia presentation when the at least one sensor determines when the remote monitor device has been removed a user.

In another exemplary aspect of the present invention, a remote monitor device for reproducing audio and/or video of a multimedia presentation include, wires or a wireless transmission protocol for receiving audio and/or video of the multimedia presentation, at least one speaker and/or display for reproducing audio and/or video from the wires or wireless transmission protocol, at least one sensor for determining when the remote monitor device has been applied to a user, and when the remote monitor device has been removed from the user, and means for transmitting a signal from the at least one sensor to one of initiate and resume the multimedia presentation when the at least one sensor determines when the remote monitor device has been applied to a user, and to one of pause and stop the multimedia presentation when the at least one sensor determines when the remote monitor device has been removed from the user.

With its unique and novel features, the present invention provides a system and apparatus for controlling the playback of a multimedia player through signals generated by sensors in the audio headphones.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a first exemplary embodiment of the multimedia playback system, according to an exemplary aspect of the present invention; and

FIG. 2 illustrates a second exemplary embodiment of the multimedia playback system, according to an exemplary aspect of the present invention.

### DETAILED DESCRIPTION OF EXEMPLARY EMBODIMENTS OF THE INVENTION

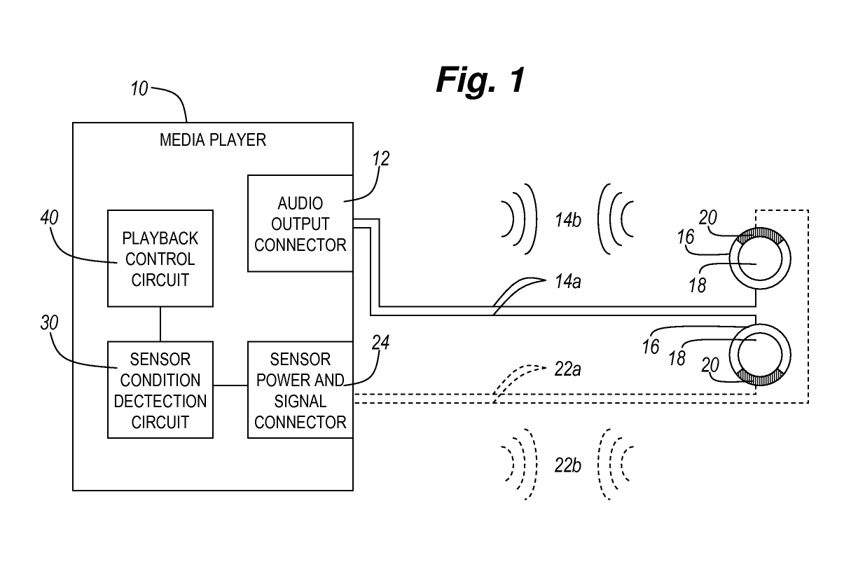

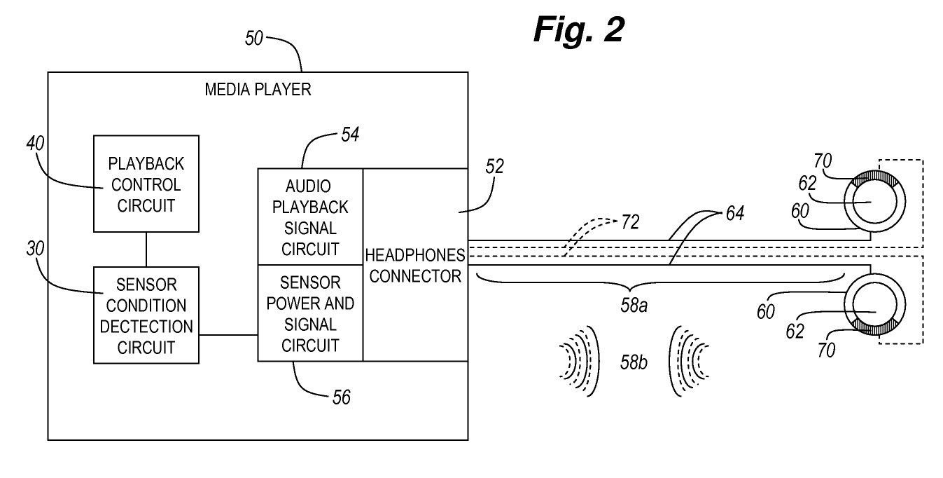

Referring now to FIGS. 1 and 2, there are shown exemplary embodiments of the system and structures of the present invention.

A first exemplary embodiment of the present invention as illustrated in FIG. 1 shows a media player 10 for playing a multimedia presentation which typically includes an audio output connector 12 for a user to connect a headphone listening device to listen to an audio portion of the multimedia presentation. Additionally, the media player 10 may output video for display locally to a screen on the media player 10 or to a remote portable eye-type video monitor. Typically, a pair of headphone wires 14a are connected the audio output connector 12 at a terminal end and are connected to a pair of headphones 16 on the opposite end. Additionally, a wireless transmission protocol 14b, such as Bluetooth, may be used to transmit a multimedia signal to a wearable remote monitor device. Headphones 16 have a speaker 18 for reproducing the audio signal from the multimedia presentation. Headphones 16 are typically supported by the user's head, ears, or a portion of the inner ear. Additionally, the headphones 16 as illustrated in FIG. 1, may be incorporated into a device that includes both headphones and a portable eye-type video monitor, (not shown). The present invention applies to either the headphones for audio playback independently, or a combination of headphones with a portable eye-type video monitor for both audio and video playback.

The present invention includes sensors 20 on a portion of the headphones 16 that are designed to come into contact with the user when worn. A purpose of the sensors 20 is to determine whether the headphones 16 are being worn by the user, or have been removed from the user during playback of a multimedia presentation. The sensors 20 may include any type of sensor or combination of sensors that are able to determine the proximity of a portion of a user's head where the headphones 16 are typically worn.

Sensors 20 may include, for example, temperature sensors that determine the presence or absence of a temperature of a user when worn. Sensors 20 may include a proximity or inductance sensor that determines a variation in the field strength of electromagnetic field when placed near a portion of the user's head where headphones 16 are typically worn. Sensors 20 may include an infrared sensor that determines the presence of an infrared source on a portion of the user's head where headphones 16 are typically worn. Sensors 20 may include a pressure sensor that is activated when the headphones 16 are placed upon a portion of the user's head where headphones 16 are typically worn. Sensors 20 may include a contact switch that is activated when it comes into contact with a portion of the user's head where the headphones 16 are typically worn.

Sensors 20 of the first exemplary embodiment of the invention in FIG. 1 communicate via a sensor signal path 22a back to the media player 10 connected to a sensor power and signal connector 24 that receives a signal from sensors 20 and that may provide power to the sensors 20. Sensor signal path 22a may provide power and communication over a single conductor, or may provide separate conductors for power and sensor communication with media player 10.

Additionally, a wireless sensor signal path 22b may be a wireless transmission protocol like Bluetooth, and may incorporate both the wireless sensor signal path 22b and wireless transmission protocol 14b. In this alternative configuration, the sensors 20 would be remotely powered via an external power source such as a battery.

When the sensor power and signal connector 24 receives a signal from sensors 20, it communicates the sensor 20 signal to the sensor condition detection circuit 30. Sensor condition detection circuit 30 then determines the type of signal that has been received from sensors 20.

If sensors 20 transmit a signal representing the condition where a user has removed headphones 16 from a portion of the user's head where headphones 16 are worn, the sensor condition detection circuit 30 sends a signal to playback control circuit 40 to either pause or stop playback of a multimedia presentation on media player 10.

If sensors 20 transmit a signal representing the condition where a user has placed headphones 16 on a portion of the user's head where headphones 16 are worn, then the sensor condition detection circuit 30 sends a signal to playback control circuit 40 to either resume or play a paused or stopped multimedia presentation on media player 10.

An alternative configuration of the first exemplary embodiment may control of playback control circuit 40 may be accomplished by receiving a signal from only a single sensor 20 versus a signal from both sensors 20. This will allow a single earphone or ear-bud-type speaker having a sensor 20 to be used to control playback of the multimedia presentation at the media player 10. An advantage to this feature includes a user's ability to simply remove a single ear-bud from an ear rather than both speakers to control operation of the playback control circuit 40.

An advantage of the first exemplary embodiment of the invention enables headphones having sensors 20 to be backwardly compatible with media players having a discrete audio output connector, while taking full advantage of the playback control circuit 40 of media players equipped with an additional sensor power and signal connector 24.

Headphones 16 having speakers 18 and sensors 20 with dual connections to a media player, that is, headphone wires 14 and sensor signal path wires 22, may be provided independently of a media player for use with media players having no sensor signal connector and with a media players including a headphone sensor signal connector 24.

A second exemplary embodiment of the invention as illustrated in FIG. 2 shows a media player 50 for playing back a multimedia presentation that includes a headphones connector 52 enabling a user to listen to an audio portion of a multimedia presentation. Connected to the headphones connector 52 is an audio playback signal circuit 54 that provides an audio playback signal to externally connected headphones, and a sensor power and signal circuit 56 used in conjunction with a pair of sensor integrated headphones.

Headphones connector 52 is connected at a terminal end to a headphones connection cord 58a that is connected to a pair of headphones 60 on an opposite end. A headphones audio signal path 64 connects to speakers 62 for reproducing the audio signal from the multimedia presentation.

Alternatively, headphones connector 52 may be connected to a wireless transmission protocol 58b for communicating audio to headphones 60.

Additionally, the headphones 60 as illustrated in FIG. 2, may be incorporated into a device that includes both headphones and a portable eye-type video monitor, (not shown). The present invention applies to either the headphones for audio playback independently, or a combination of headphones with a portable eye-type video monitor for both audio and video playback.

This alternative exemplary embodiment includes sensors 70 in a portion of the headphones 60 that come into contact with the user, similar to the first exemplary embodiment illustrated in FIG. 1. Again, the purpose of sensors 70 are to determine whether the headphones 60 are being worn by the user, or have been removed from the user during playback of a multimedia presentation. The sensors may be similar to the list of previously recited sensors and may be in configured in sensor combinations thereof as described above in the first embodiment of the invention.

Sensors 70 communicate via a sensor signal path 72 to the media player 50 via the headphones connection cord 58a or wireless transmission protocol 58b. In the second exemplary embodiment of the invention, a single connection or wireless transmission at the headphones connector 52 connects both the audio signals transmitted on headphones audio signal path of 64 and the sensor signal path 72.

Sensors signal path 72 may also provide power from sensor power and signal circuit 56 to sensors 70. Sensor signal path 72 may provide power and communication over a single conductor, or may provide separate conductors for power and sensor communication with the media player 50. However, when wireless transmission protocol 58b is used, the sensors 70 would be remotely powered via an external power source such as a battery.

When the sensor power and a signal circuit 56 receives a signal from sensors 70, it communicates the sensors 70 signal to sensor condition detection circuit 30. Sensor condition detection circuit 30 then determines the type of signal that has been received from the sensors 70.

If sensors 70 transmit a signal representing the condition where a user has removed headphones 60 from a portion of the user's head where headphones 60 are worn, then the sensor condition detection circuit 30 sends a signal to playback control circuit 40 to either pause or stop playback of a multimedia presentation on media player 50.

If sensors 70 transmit a signal representing the condition where a user has placed headphones 60 on a portion of the user's head where headphones 60 are worn, then the sensor condition detection circuit 30 sends a signal to playback control circuit 40 to either resume or play the paused or stopped multimedia presentation on multimedia player 50.

As above, an alternative configuration of this second exemplary embodiment may control playback control circuit 40 by receiving a signal from a single sensor 70 in versus receiving a signal from both sensors 70. This configuration allows a single earphone or ear-bud-type speaker to control playback of the multimedia presentation at the media player 10 when it is removed from the user.

An advantage of the second exemplary embodiment of the present invention allows for a single headphones connector 52 to be connected to a novel headphones connection cord 58 that incorporate both a headphones audio signal path 64, and a sensor signal path 72 that may provide both power and signal transmission to sensors 70.

An additional feature of the present invention includes the ability of placing the sensors 20, 70 on any portion of the headphones 16, 60 that come into contact with a portion of the user's head where headphones 16, 60 are typically worn. Headphones having an ear-bud-type configuration designed to be worn in the ear may have sensors 20, 70 very near the speakers 18, 62. Alternatively, headphones having padded ear supports designed to be worn on top of or around the ear, (known as partial or full-enclosure earphones), may have sensors 20, 70 located in the padding or any other portion of the headphone assembly that may come into contact with a portion of the user's head when wearing the headphone assembly. As mentioned above, a remote personal monitoring device may include a combination of headphones and a wearable eye-type display device that includes sensors operate in the same manner as described above.

With its unique and novel features, the present invention provides a system and apparatus to both listen to an audio or video signal of a multimedia presentation from a media player, and to control playback of the multimedia presentation by detecting the removal and replacing of a single headphone, a pair of headphones or a combination of headphones and personal eye-type monitor device on a user.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A multimedia playback system, said system comprising:
a multimedia player including a playback control circuit that controls playback of a multimedia presentation; and
a remote monitor device for remotely reproducing at least one of audio and video of said multimedia presentation, said remote monitor device comprising:
means for receiving at least one of audio and video of said multimedia presentation;
at least one of a speaker and a display for reproducing at least one of audio and video from said means for receiving; and
at least one sensor for determining when said remote monitor device has been applied to a user, and when said remote monitor device has been removed from the user,
wherein said multimedia player further comprises:
a multimedia signal connector for connecting to said means for receiving at least one of audio and video input for remote multimedia presentation reproduction;
a sensor power and signal connector for connecting and providing power to said at least one sensor; and
a sensor condition detection circuit for controlling said playback control circuit to one of initiate and resume said multimedia presentation when said at least one sensor determines when said remote monitor device has been applied to a user, and for controlling said playback control circuit to one of pause and stop said multimedia presentation when said at least one sensor determines when said remote monitor device has been removed from the user.

2. The multimedia playback system according to claim 1, wherein said at least one sensor comprises at least one sensor from the group of:
a temperature sensor;
a proximity sensor;
an infrared sensor;
a pressure sensor; and
a contact switch.

3. A multimedia playback system, said system comprising:
a multimedia player including a playback control circuit that controls playback of a multimedia presentation; and
a remote monitor device for remotely reproducing at least one of audio and video of said multimedia presentation, said remote monitor device comprising:
means for receiving at least one of audio and video of said multimedia presentation;
at least one of a speaker and a display for reproducing at least one of audio and video from said means for receiving; and
at least one sensor for determining when said remote monitor device has been applied to a user, and when said remote monitor device has been removed from the user,
wherein said multimedia player further comprises:
means for communicating with said means for receiving at least one of audio and video input for remote multimedia presentation reproduction and for communicating with said at least one sensor; and
a sensor condition detection circuit for controlling said playback control circuit to one of initiate and resume said multimedia presentation when said at least one sensor determines when said remote monitor device has been applied to a user, and for controlling said playback control circuit to one of pause and stop said multimedia presentation when said at least one sensor determines when said remote monitor device has been removed from the user.

4. A remote monitor device for reproducing at least one of audio and video of a multimedia presentation, said remote monitor device comprising:
means for receiving at least one of audio and video of a multimedia presentation;
at least one of a speaker and a display for remotely reproducing one of audio and video from said means for receiving;
at least one sensor for determining when said remote monitor device has been applied to a user, and when said remote monitor device has been removed from the user; and
means for transmitting a signal from said at least one sensor to one of initiate and resume said multimedia presentation when said at least one sensor determines when said remote monitor device has been applied to a user, and to one of pause and stop said multimedia presentation when said at least one sensor determines when said remote monitor device has been removed from the user.
